(19) United States
(12) Patent Application Publication
(10) Pub. No.: US 2009/0113481 A1
(43) Pub. Date: Apr. 30, 2009

(54) SYSTEMS, METHODS AND COMPUTER PROGRAM PRODUCTS FOR PROVIDING PRESENCE BASED SERVICES

(75) Inventor: Lee G. Friedman, Alpharetta, GA (US)

Correspondence Address: AT&T Legal Department - CC;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/208,656

(22) Filed: Sep. 11, 2008

Related U.S. Application Data
(60) Provisional application No. 60/982,173, filed on Oct. 24, 2007.

(51) Int. Cl. H04N 5/445

(52) U.S. Cl. 725/46

(57) ABSTRACT

Systems, methods, and computer program products for providing presence-based services are disclosed. A method includes collecting information relating to devices at a subscriber entity. The information includes one or more of: device characteristics, an identity of a user of a first device, and type of content or services currently active on the first device. The identity is determined through authentication. The method also includes transferring content or services currently exhibited on the first device to a second device upon determining the user is no longer active on the first device and is active and authenticated on the second device. The content or services is transferred in a format corresponding to the type of content or services and device characteristics of the second device.

### CROSS-REFERENCE TO RELATED APPLICATION

This application claims priority from U.S. Provisional Application No. 60/982,173, filed Oct. 24, 2007, the entire contents of which are herein incorporated by reference.

### BACKGROUND

Exemplary embodiments relate generally to providing services to users, and in particular providing services to users based on a user's presence.

Existing providers of services such as cable television, satellite television, and Internet protocol television (IPTV) have little or no information concerning the user currently accessing services. This limits customization of the experience to a user of devices such as a set top box. There is no ability to customize the experience based on user preferences or direct services to an individual user of a service. Further, a user's current state (e.g., channel being watched) cannot be saved, restored or moved to another device. Thus, there is a need in the art for techniques of providing services in response to, at least in part, the user's presence.

### SUMMARY

Exemplary embodiments include methods for providing presence-based services. A method includes collecting information relating to devices at a subscriber entity. The information includes device characteristics, an identity of a user of a first device, and type of content or services currently active on the first device. The identity is determined through authentication. The method also includes transferring content or services currently exhibited on the first device to a second device upon determining the user is no longer active on the first device and is active and authenticated on the second device. The content or services is transferred in a format corresponding to the type of content or services and device characteristics of the second device.

Exemplary embodiments also include systems for providing presence-based services. A system includes a host system and a presence-based application executing on the host system. The presence-based application implements a method. The method includes collecting information relating to devices at a subscriber entity. The information includes device characteristics, an identity of a user of a first device, and type of content or services currently active on the first device. The identity is determined through authentication. The method also includes transferring content or services currently exhibited on the first device to a second device upon determining the user is no longer active on the first device and is active and authenticated on the second device. The content or services is transferred in a format corresponding to the type of content or services and device characteristics of the second device.

Further exemplary embodiments include computer program products for providing presence-based services. A computer program product includes a computer readable medium having program code embodied thereon. The program code is executed by a computer to implement a method. The method includes collecting information relating to devices at a subscriber entity. The information includes device characteristics, an identity of a user of a first device, and type of content or services currently active on the first device. The identity is determined through authentication. The method also includes transferring content or services currently exhibited on the first device to a second device upon determining the user is no longer active on the first device and is active and authenticated on the second device. The content or services is transferred in a format corresponding to the type of content or services and device characteristics of the second device.

Other systems, methods, and/or computer program products according to embodiments will be or become apparent to one with skill in the art upon review of the following drawings and detailed description. It is intended that all such additional systems, methods, and/or computer program products included within this description, be within the scope of the present application, and be protected by the accompanying claims

### BRIEF DESCRIPTION OF THE DRAWINGS

Referring now to the drawings wherein like elements are numbered alike in the several FIGURES:

FIG. 1 is a system diagram illustrating a server side architecture in exemplary embodiments where services are provided on an IPTV platform;

FIG. 2 is a system diagram illustrating a client-side architecture in exemplary embodiments where services are provided on an IPTV platform;

FIG. 3 is a diagram illustrating an example of a user service experience following the user from one location to another;

FIG. 4 is a diagram illustrating a hierarchy used for assigning settings for multiple users in an exemplary embodiment;

FIG. 5 illustrates an exemplary user interface depicting users who are logged into each service and allowing users to log in to different services through drop down menus;

FIG. 6 illustrates an exemplary user interface depicting administrative control of users and user settings;

FIG. 7 a flowchart of a process for authenticating a user based on a device in an exemplary embodiment; and

FIG. 8 illustrates an example of authenticating a personal device in an exemplary embodiment.

### DETAILED DESCRIPTION

Embodiments include methods, systems and computer program products for providing presence based services. Presence includes one or more of who a user is, what service or services the user is receiving and where the user is located. The presence service is integrated into an existing infrastructure providing services to augment the user experience. As described in further detail herein, the user logs into the presence service. Once the user is authenticated by the presence service, the presence service returns user preferences (e.g., favorite channel, movie preferences) along with transferring any live state held in any device the user previously logged into. Once a user logs in, the presence service records the user's current state (e.g., channel being viewed, set top box ID). Using this presence information, the presence service can direct services to a specific user based on a variety of factors. The presence service also stores specific preferences for different applications in the presence infrastructure and restores these preferences on a per user basis to a specific device.

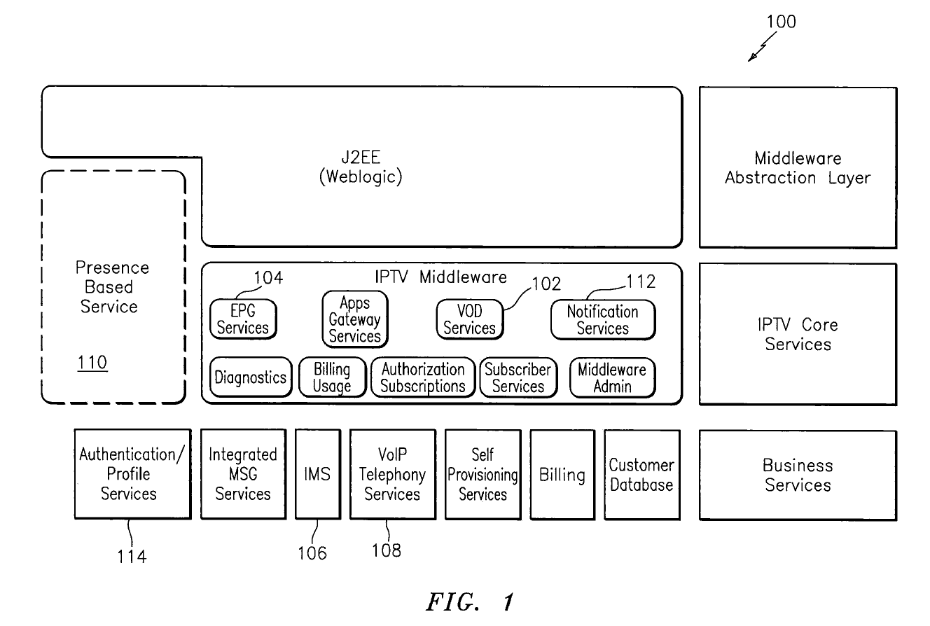

FIG. 1 is a system diagram illustrating a server side architecture 100 in exemplary embodiments where services are provided on an IPTV platform. It is understood that the presence-based services may be offered on other platforms, such as cable, satellite or wireless. The architecture 100 includes a number of existing service applications such as Video on Demand (VOD) 102, Electronic Program Guide (EPG) 104, Instant Messaging Service (IMS) 106, and VoIP telephony 108. A presence based service application 110 interfaces with other modules to provide enhanced services to a user in response to user presence as described in further detail herein.

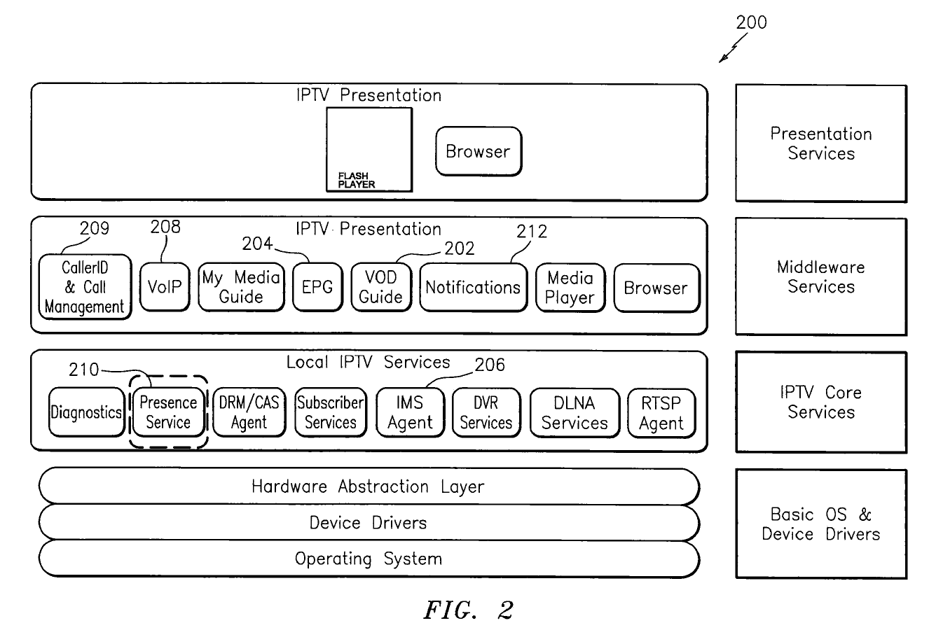

FIG. 2 illustrates a client-side architecture 200 in exemplary embodiments where services are provided on an IPTV platform. It is understood that the presence-based services may be offered on other platforms, such as cable, satellite or wireless. A client side device (e.g., a computing device such as a set top box (STB)) implementing the architecture 200 includes applications corresponding to various services offered by the service provider such as Video on Demand (VOD) 202, Electronic Program Guide (EPG) 204, Instant Messaging Service (IMS) 206, VoIP telephony 208, caller ID and call management 209. Client side devices implementing the architecture 200 also include a presence service application 210 as shown in FIG. 2. According to exemplary embodiments, the client presence service application 210 collects user settings and interfaces with the server preference based services provided by the architecture 100 of FIG. 1, as described in further detail herein.

The presence-based services allow a user experience to follow the user from device to device by allowing the user to specify their own personal settings. As described in further detail herein, a user logs in using a number of different approaches. Once the user is logged in, their personal settings are applied and the user can continue a user experience previously accessed by the user.

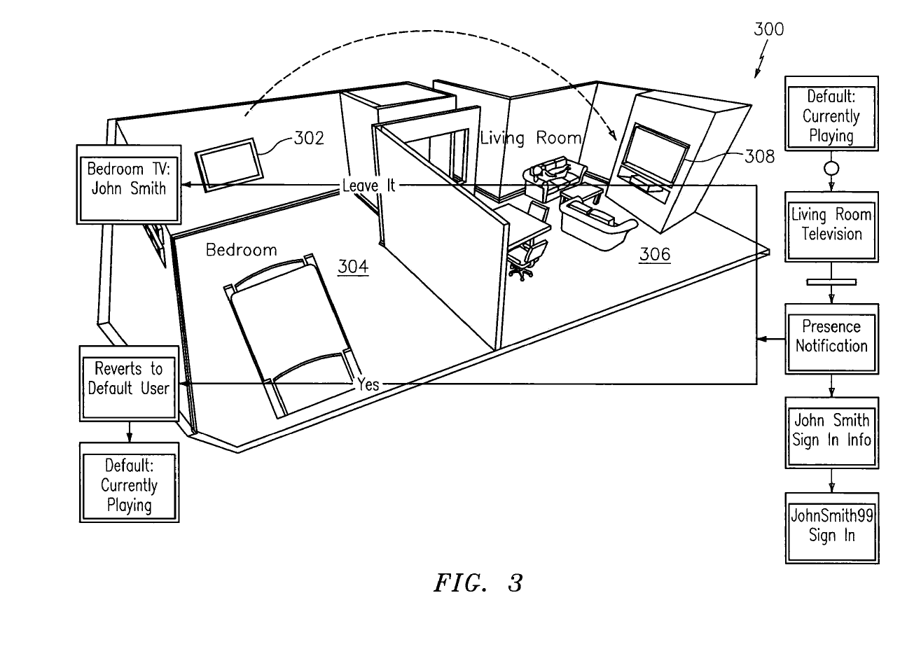

FIG. 3 illustrates an example of a user service experience following the user from one location to another within a household 300. A user, John Smith, is logged into a device 302 (e.g., a STB) in a bedroom 304 obtaining service A (e.g., video on demand 102). The device 302, upon log in, is referred to as ‘active.’ The user decides to move to a living room 306 to continue receiving service A. When John first turns on a television 308 (via an STB, for example), a default service B is being provided (e.g., cable television) and the user is prompted if they want to log in through a presence notification 212. Presence notification services 112 shown in FIG. 1 provide this notification 212. If John does not log in, then the default service B (cable TV) is maintained. If John does log in, the client presence service 210 loads John's settings and also recognizes that John is logged in on the STB in the bedroom 304. The STB in the living room 306 queries if John would like to continue service A that was being experienced in the bedroom 304. If John responds positively, the STB in the living room 306 provides service A. In one embodiment, the content or services of the service A is transferred to the device in the living room 306. The query may prompt John to either transfer the content or services from service A to the device in the living room 306, or maintain the content or services of service A on the device in the bedroom 304 while simultaneously providing the service A on the device in the living room 306. Alternatively, John may select an option to discontinue service A in the bedroom 304. If John signs out from the living room 306 STB, the service provided reverts to the default service B.

The above example depicts services following a user from room-to-room. This is possible as the devices (e.g., the STBs) in the home are in communication and can determine what other devices the user is logged into and the experiences being provided on the other devices. This feature may be extended beyond a single home to multiple locations. As long as the devices can communicate and are authorized to share user settings and presence information, then services may follow a user anywhere. For example, John's sister Mary may agree to form a presence network with John so that John's log in is recognized by Mary's devices and John's settings and presence information is accessible by Mary's devices. If John is watching a movie on VOD and pauses the movie, he can resume the movie at Mary's by logging in on Mary's device. The devices (e.g., STBs) are in communication over a network and have been authorized to share to such information. The presence services provide users the ability to set up such collaborative device networks through user interfaces. The user may need to enter unique information, such as account numbers and other security information in order to network geographically dispersed devices to access presence information from each device.

The example of FIG. 3 can also be expanded to altering content or services depending on the device that the user is logged into. For example, if John is viewing online pictures from a family vacation on a TV and then logs in to a cellular phone but continues the service, then the image size may be altered to accommodate the reduced screen size of the cellular phone, which represent device characteristics such as bandwidth capability and resolution capability of the devices. Because the presence service knows who the user is and what device the user is logged into, the content or services may be altered to fit the user and the user device capabilities.

Further, user settings can vary depending on the location where the service is being provided. If John is in his bedroom 304 viewing a VOD movie, the rating may be unlimited as John typically is the only user of this television 302. If John leaves the bedroom 304 and goes to the living room 306 (the example of FIG. 3) and logs in, the service may change based on John's settings for the living room 306. John may desire that all VOD movies viewed on the living room television 308 be limited to PG-13 format as his children are often present. In this scenario, the content or services may be altered to provide a different version of the content or services depending on the user and the device logged into.

Knowing which device the user is logged into also facilitates providing the notification services 112 for communications, such as the instant messaging 106. If a notification (e.g., via the notifications 212) needs to be delivered to John, and there is no indication of which device John is using, then the notification is broadcast to all devices. If John is logged onto a certain device (e.g., an STB) then the notification may be sent directly to that STB for display on the television.

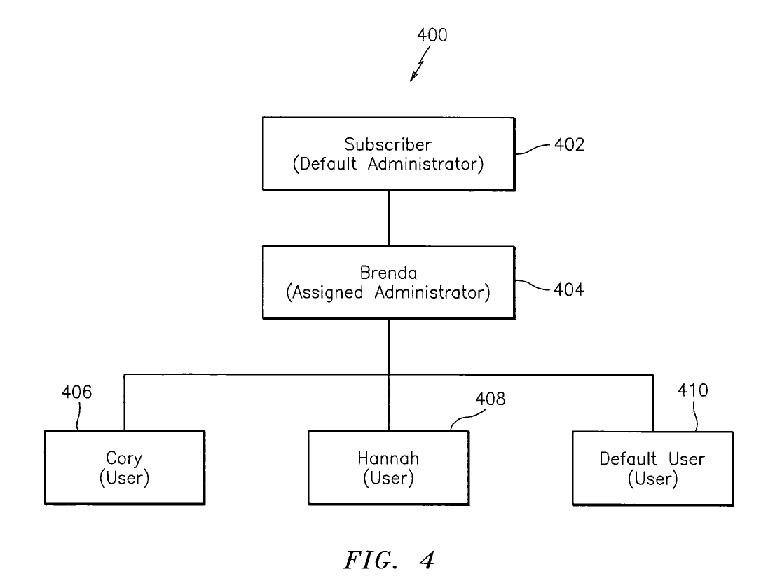

FIG. 4 illustrates a hierarchy 400 used for assigning settings for multiple users of the presence based services. The settings relate to a variety of features including entitlements to services (e.g., what services can be accessed), allowances (e.g., time limits), parental controls, access times, etc. At the top of the hierarchy is a subscriber 402 who is initially set as the Default Administrator. This is typically the individual listed on the invoice for the services. The subscriber 402 has authority to appoint one or more assigned administrators 404 and, in the example of FIG. 4, Brenda has been assigned as the administrator 404. The subscriber 402 and the assigned administrator 404 have the same rights as far as setting user settings.

Users in the hierarchy shown in the example of FIG. 4 are Cory 406, Hannah 408, and a default user 410. Depending on ages, etc., Cory 406 and Hannah 408 may have different settings. The default user 410 is a profile that is used when no one is logged into a device. This profile is intended to accommodate the user with the least privileges. For example, if Hannah 408 is the youngest child, then the default user profile would contain settings for content or services appropriate for Hannah 408. The default profile 410 may be described as having equal or fewer rights than the rights of the lowest user.

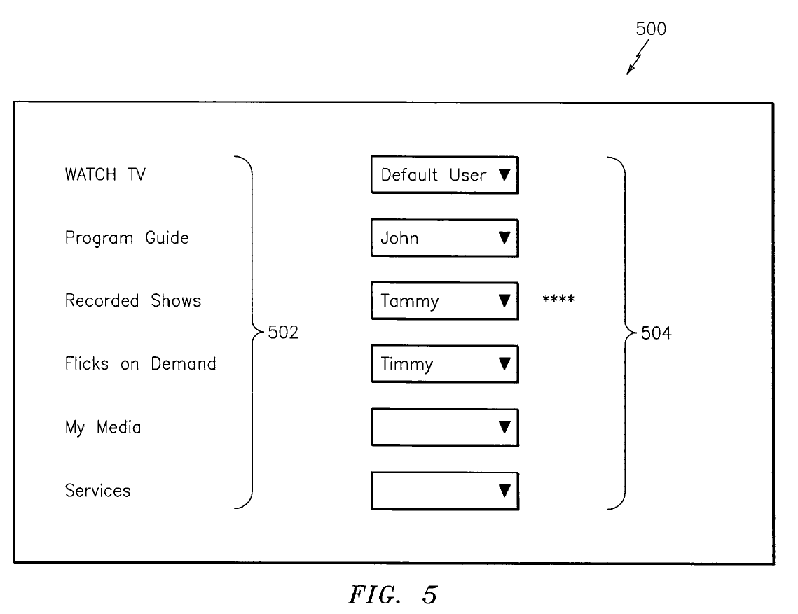

FIG. 5 illustrates an exemplary user interface 500 depicting which users are logged into each service 502 and allowing users to log in to different services through drop down menus 504. Users may be required to enter a personal identification number (PIN) to log into the presence-based service 502. If no PIN is required, then a user may simply select their name from a log in menu. If a PIN is required, then the user may enter the PIN through an onscreen window that pops up when a certain button is pressed. Alternatively, the service 502 may be configured for a quick code entry. According to exemplary embodiments, for a quick code entry, the user simply enters a number of digits, such as 4 digits, on an input device (e.g., remote control). When the STB receives these four digits sequentially in a predetermined period of time, it recognizes that the user is attempting to enter a PIN. The PIN is then compared to recorded PINs to determine who the user is and to log the user in if the PIN matches a PIN on record, e.g., from records stored by an authentication/profile services 114 shown in FIG. 1.

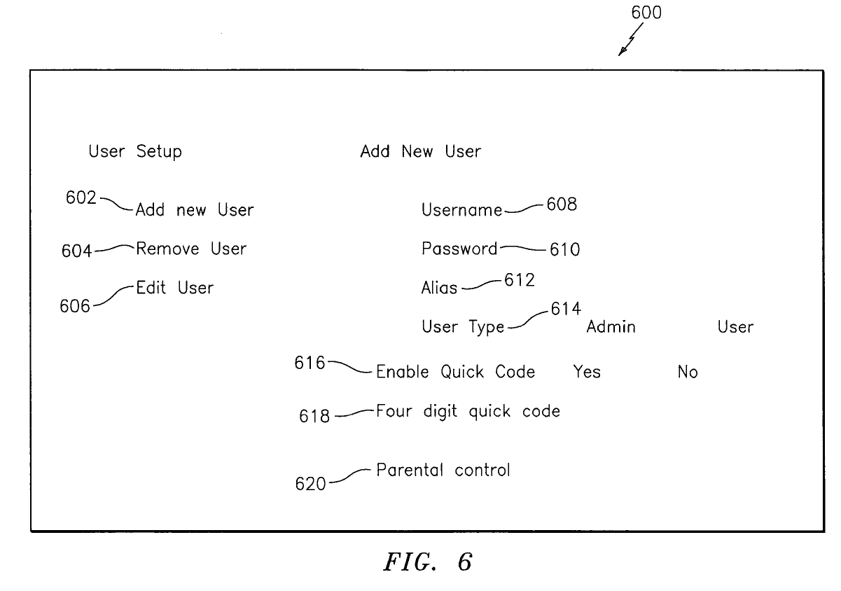

FIG. 6 illustrates an exemplary user interface 600 depicting administrative control of users and user settings. As shown in FIG. 6, an administrator (e.g., the subscriber 402 or the assigned administrator 404 of FIG. 4) may add new users 602, remove users 604, and edit user settings 606. A new user may be given a user name 608, password 610, alias 612, and user type 614 (administrator or user). The user may have a quick code 616 enabled allowing the user to enter a multi-entry alphanumeric code 618 that is recognized by the device without further entries. Parental controls 620 may also be set from this menu.

In alternate embodiments, user devices are used to authenticate a user and log a user into the presence-based services. One drawback of existing user authentication processes is that user identification for authentication on the web and TV require using a combination of a username and a password. Some concerns are that people forget their username/password combinations, services require periodic changes to passwords to maintain security, each service requires a separate username/password combination, and some services require that multiple devices be authenticated and associated with a user before the service can be used.

Today, more and more people use personal devices with network connections (e.g., cell phone, personal media player (such as the ipod), PDAs). Each device has a unique identifier associated only with that device (e.g., phone number for cell phone, MAC address for network connected personal media player, burned in serial number all retrievable via software request). Embodiments allow a user to authenticate themselves using a device associated with that user.

Some terminology is helpful in reviewing these embodiments. A device identification ID (DI) may be an alphanumeric value that is uniquely and permanently assigned to a device. An Authenticating Software Agent (ASA) is a software component that reads the device ID and performs the login process. An authentication service (AuS) is a service used by the ASA to obtain the authentication (e.g., Kerberos, Radius, RSA Authentication Manager, CA Siteminder). An entitlements key (EK) is a software encrypted key issued to entitle an authenticated user to use a cluster of services (e.g., CA Entitlement Manager). A personal device (PD) is a class of devices with personal data (e.g., music, video, calendar, address book, etc.)

Embodiments allow a user to use the personal device owned by an individual as the authentication mechanism. This precludes the need to remember complex authentication pairs (username/password) and provides instant access to all services using the identifier (single sign on method). The PD is always associated with a particular user. Secondary security measures may be available to user (e.g., a lock code for a cell phone).

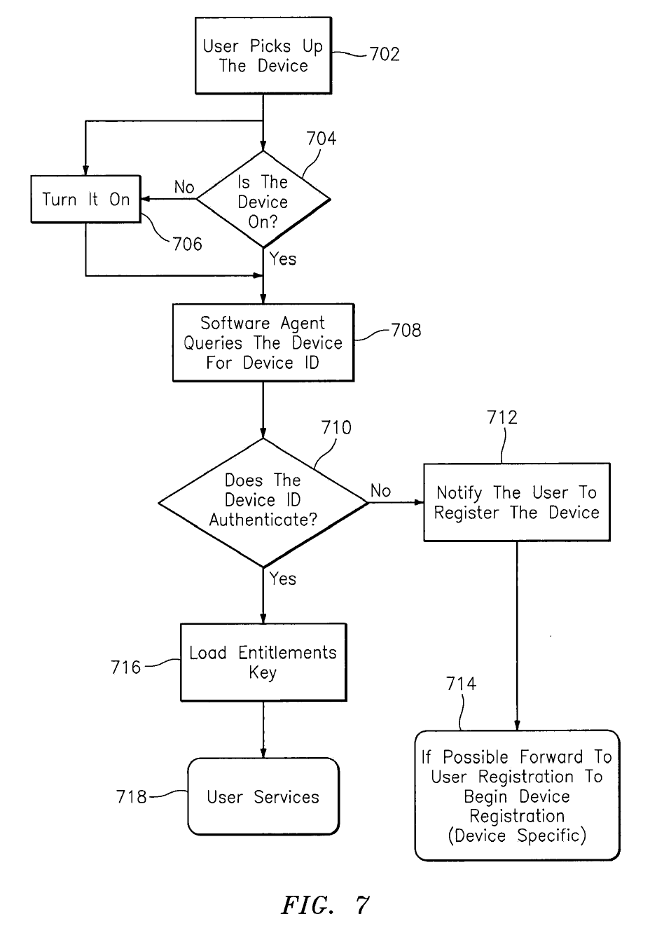

FIG. 7 is a flowchart of a process for authenticating a user based on a device. Initially, the user accesses the PD at step 702 and, if the device is not already on at step 704, the user turns the device on at step 706. A device agent queries the PD for a device ID at step 708. The device agent may be an application executing on a local network device such as an STB. The PD communicates with the local device using known communication techniques. A PDA, for example, may use WiFi communication. A cellular phone may use wireless communications techniques, including SMS. A portable media player may be connected to a port on the network device through a cable or direct interface on the network device.

Once the PD is communicating with the network device, the device ID is retrieved from the PD and passed to an authentication service (e.g., the authentication/profile services 114 of FIG. 1) to log in the user. According to exemplary embodiments, this entails comparing the device ID to a stored list of device IDs. Devices are registered with the user's profile which is stored in the user account located in the database of the authentication system. This may be done locally at the network device or remotely at a server in communication with the local client network device. Once logged in at step 710, an entitlements key is passed to the network device at step 716 to access services and retrieve user preferences associated with the user on that device (or for the device set) at step 718.

If the device ID is not recognized at step 710, then the user is notified to register the PD at step 712. This may be done in a variety of manners. If the PD has a keyboard and a user interface to support a login screen, then the user accesses a registration process and is prompted for a username and password. The user enters username and password and an ASA creates a message combining the username, password and device ID (optionally a device name could be added as a reference). The message is sent to Authentication Service and the user profile is updated with the new device ID at step 714.

If the PD lacks a keyboard and user interface, then the Authentication Software Agent presents the Device ID to the user and the user employs a browser on a computer to login into their account and add the device ID (and optional name) into their profile.

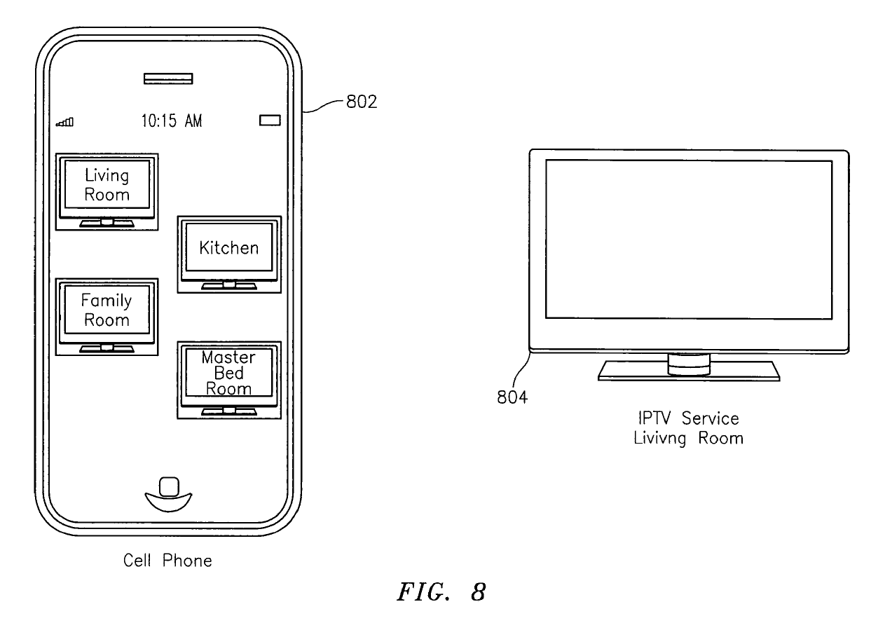

FIG. 8 is a diagram illustrating an example authentication of a PD. A user uses a cellular phone 802 to select a TV 804 in his home he wants to control through a touch screen interface. The phone 802 is authenticated to the system using his cell phone number being transmitted to the STB and to the authentication network. Once authenticated, the entitlement key is delivered to the cell phone 802 and the STB of the TV 804. User preferences and entitlements are loaded into the STB to customize the user experience.

As described above, the exemplary embodiments can be embodied in the form of computer-implemented processes and apparatuses for practicing those processes. The exemplary embodiments can also be embodied in the form of computer program code containing instructions embodied in tangible media, such as floppy diskettes, CD ROMs, hard drives, or any other computer-readable storage medium, wherein, when the computer program code is loaded into and executed by a processor, the processor becomes an apparatus for practicing the embodiments. The exemplary embodiments can also be embodied in the form of computer program code, for example, whether stored in a storage medium, loaded into and/or executed by a computer, or transmitted over some transmission medium, loaded into and/or executed by a processor, or transmitted over some transmission medium, such as over electrical wiring or cabling, through fiber optics, or via electromagnetic radiation, wherein, when the computer program code is loaded into and executed by a processor, the processor becomes an apparatus for practicing the embodiments. When implemented on a general-purpose microprocessor, the computer program code segments configure the microprocessor to create specific logic circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Further, the processes described are not necessarily to be performed only in the sequence illustrated or each step only at the time indicated. Therefore, it is intended that the invention not be limited to the particular embodiment disclosed as the best mode contemplated for carrying out this invention, but that the invention will include all embodiments falling within the scope of the disclosure.

What is claimed is:

1. A method for providing presence-based services, comprising:
collecting information relating to devices at a subscriber entity, the information including one or more of: device characteristics, an identity of a user of a first device, and type of content or services currently active on the first device, the identity determined through authentication; and
transferring content or services currently exhibited on the first device to a second device upon determining the user is no longer active on the first device and is active and authenticated on the second device, the content or services transferred in a format corresponding to the type of content or services and device characteristics of the second device.

2. The method of claim 1, further comprising:
sending a notification to the second device in response to the authentication of the user at the second device, the notification prompting the user to select from options including:
maintaining the content or services on the first device simultaneously with the content or services transferred to the second device; and
discontinuing the content or services on the first device.

3. The method of claim 2, wherein a default service is provided upon the user selecting none of the options.

4. The method of claim 3, wherein the default service represents content or services currently active on the second device absent the transfer of content or services from the first device.

5. The method of claim 1, further comprising:
identifying an incoming call from a third device; and
upon determining the target of the incoming call is directed to the user of the first device, presenting the incoming call at the first device.

6. The method of claim 1, wherein the devices include at least one of:
a cellular telephone;
a personal computer;
a voice over Internet Protocol (VoIP)-enabled telephone; and
a set top box of an Internet Protocol (IP)-enabled television.

7. The method of claim 1, wherein the device characteristics include at least one of:
network bandwidth capability; and
video resolution capability.

8. The method of claim 1, wherein the subscriber entity is a member of a household.

9. A method for providing authentication for users of presence based services, comprising:
determining whether a device has been registered for receiving the presence based services, comprising:
accessing a list of device identifiers registered with a user account; and
searching the list for a device identifier associated with the device;
if present, retrieving the device identifier and sending an entitlements key associated with the device identifier to the device;
if not present, prompting a user at the device to register the device; and
upon successful registration and authentication of the device, providing presence based services to the device, the presence based services include using the device identifiers and the identities determined through authentication to provide content to the respective devices based upon the entitlements.

10. The method of claim 9, wherein the presence based services further include discontinuing presentation of content that is active on one of the devices and initiating presentation of the content on another of the devices when it is determined that a user of one of the devices becomes authenticated on another of the devices and the type of content available on the other of the devices is within the entitlements granted by the entitlement key.

11. The method of claim 9, wherein the registration includes:
prompting the user to enter a user name and password;
creating a message that combines the username, password, and the device identifier; and
updating the user account with the message to reflect the registration.

12. The method of claim 9, wherein the user account is stored on the device.

13. The method of claim 9, wherein the device includes at least one of:
cellular telephone;
a personal computer;
a set top box of an Internet Protocol (IP)-enabled television; and
a voice over Internet Protocol (VoIP)-enabled telephone.

14. A method for providing communication services to users of a subscription to a service based on assigned user rights, comprising:
providing a default administrator with access to the communication services based on assigned rights, wherein the default administrator has at least as many rights of any user of the communication services;
providing an administrator with access to the communication services based on assigned rights for usage determined by the default administrator;
providing various other users individual rights to usage of the communication services;
collecting information relating to devices at a subscriber entity, the information including identities of users of the devices and type of content available on the devices, the identity determined through authentication; and
discontinuing a communication service that is active on one of the devices and initiating the communication service on another of the devices when it is determined that a user of the active communication service becomes authenticated on the other of the devices and the type of content available on the other of the devices is within the assigned access rights for the user.

15. The method of claim 14, wherein the assigned administrator has the same rights of usage to the communication services as the default administrator.

16. The method of claim 14, wherein the default administrator is a subscriber to the communication services.

17. The method of claim 14, wherein the communication services provided to the various other users are based on at least one of entitlements, allowances, parental control, access times, restricted access, and user customizable settings.

18. The method of claim 14, wherein the default administrator assigns the rights to usage of the communications services to the assigned administrator.

19. The method of claim 14, wherein the default administrator assigns the rights to usage of the communication services to the various other users.

20. The method of claim 14, wherein the various other users include a default user having rights based on a defined user with the least rights assigned.

21. The method of claim 14, wherein the communication services are provided responsive to a user logging in, and if no user logs in, communication services provided are those assigned to the default user.
